(19) United States
(12) Patent Application Publication
(10) Pub. No.: US 2009/0236104 A1
(43) Pub. Date: Sep. 24, 2009

(54) NEGATIVE PRESSURE ACTUATOR

(75) Inventors: Joseph K. Banis, Alpha, NJ (US); Kevin J. Blease, Easton, PA (US); William J. Reilly, Langhorne, PA (US); Kerry A. Stewart, Easton, PA (US)

Correspondence Address: Ballard Spahr Andrews & Ingersoll, LLP, SUITE 1000, 999 PEACHTREE STREET, ATLANTA, GA, 30309-3915, US

(73) Assignee: Victaulic Company, Easton, PA (US)

(21) Appl. No.: 12/050,375

(22) Filed: Mar. 18, 2008

(51) Int. Cl. A62C 35/64; A62C 35/68

(52) U.S. Cl. 169/16; 169/20

(57) ABSTRACT

An actuator for use with a negative pressure fire suppression sprinkler system is disclosed. The actuator has three chambers, each chamber having a flexible diaphragm. One chamber is connected to the sprinkler system piping network. Its diaphragm moves in response to an increase in pressure in the piping network signaling a fire. The diaphragm in the second chamber opens an orifice in response to the motion of the first diaphragm. The open orifice allows water to flow from the third chamber to the ambient. The diaphragm in the third chamber moves in response to the water flow from the third chamber. The third chamber is connected to a valve controlling water flow to the piping network. Motion of the diaphragm in the third chamber actuates the valve, releasing water to the system.

### FIELD OF THE INVENTION

This invention relates to pneumatic actuators for actuating valves in response to a change in gas pressure.

### BACKGROUND OF THE INVENTION

Automatic sprinkler systems for fire protection of structures such as office buildings, warehouses, hotels, schools and the like are required when there is a significant amount of combustible matter present. The combustible matter may be found in the materials from which the building itself is constructed, as well as in the building contents, such as furnishings or stored goods.

Of the various types of automatic sprinkler systems available, the “dry-pipe” system finds widespread use. Dry-pipe systems use an actuator which responds to a signal or combination of signals from different detectors to trip a valve which provides water to the sprinkler piping network. Most dry-pipe systems are of the positive pressure type, meaning that the piping network is normally filled with compressed air or nitrogen (and not water) prior to actuation. The dry-pipe system can thus be used in unheated environments which are subject to below freezing temperatures without fear of pipes bursting due to water within the pipes expanding upon freezing.

When sufficiently pressurized, the behavior of the gas within the piping network of a positive pressure dry-pipe system may be used to indicate a fire condition and trigger actuation of the system. Heat from the fire will cause sprinkler heads to open, allowing pressurized gas to escape from the piping network and resulting in a pressure drop within the piping network. Actuation of the system may be effectively triggered by this pressure drop.

Positive pressure dry-pipe systems are not without their disadvantages however. Such systems use compressed air drawn from the ambient atmosphere to pressurize the piping network. This introduces moisture and oxygen into the piping network, creating conditions within the pipes which favor microbiological influenced corrosion (MIC).

MIC can lead to significant problems in piping networks of fire suppression systems. Microbiological entities, such as bacteria, molds and fungi introduced into the piping network with untreated water or compressed air, feed on nutrients within the piping system and establish colonies in the stagnant water or moisture within the system.

Over time, the biological activities of these living entities cause significant problems within the piping network. Both copper and steel pipes may suffer pitting corrosion leading to pin-hole leaks. Iron oxidizing bacteria form tubercles, which are corrosion deposits on the inside walls of the pipes that can grow to occlude the pipes. Tubercles may also break free from the pipe wall and lodge in sprinkler heads, thereby blocking the flow of water from the head either partially or entirely. Even stainless steel is not immune to the adverse effects of MIC, as certain sulfate-reducing bacteria are known to be responsible for rapid pitting and through-wall penetration of stainless steel pipes.

In addition to MIC, other forms of corrosion are also of concern. For example, the presence of moisture and oxygen within the piping network can lead to oxidative corrosion of ferrous materials. Such corrosion can cause leaks as well as foul the network and sprinkler heads with rust particles. The presence of water in the piping network having a high mineral content can cause scaling as the various dissolved minerals, such as calcium and zinc, react with the water and the pipes to form mineral deposits on the inside walls which can inhibit flow or break free and clog sprinkler heads, preventing proper discharge in the event of a fire.

One way to mitigate MIC and other forms of corrosion is to maintain the piping network at a negative pressure relative to the ambient atmosphere and draw air having little or no entrained moisture through the system. This will dry the piping network and starve the biological entities of their required water, rendering them inert, and largely preventing MIC.

When maintaining negative as opposed to positive pressure within the piping network, it is still possible to use the change in pressure within the system, which results when one or more sprinkler heads open, as a signal to trigger the system. For a negative pressure system, it is, of course, an increase in pressure within the system which constitutes the actuating signal. This will require different actuators from those which are currently used for positive pressure systems, which detect a decrease in the system pressure as the triggering event.

### SUMMARY OF THE INVENTION

The invention concerns a device for depressurizing a fluid contained in a first enclosed space, such as a latch valve used in a sprinkler system, in response to an increase in fluid pressure in a second enclosed space, such as the piping network of a negative pressure dry-pipe sprinkler system. The device comprises a first chamber having a flexible first diaphragm mounted therein. The first diaphragm sealingly divides the first chamber into first and second chamber portions. Both of the chamber portions are in fluid communication with the first enclosed space. The first chamber portion has an opening which provides fluid communication with the ambient. The opening is surrounded by a seat which faces the first diaphragm. The first diaphragm is deflectable into sealing engagement with the seat to seal the opening when the first enclosed space is pressurized with the fluid. A second chamber has a flexible second diaphragm mounted therein. The second diaphragm sealingly divides the second chamber into third and fourth chamber portions. The fourth chamber portion is in fluid communication with the ambient. The third chamber portion is also in fluid communication with the ambient and has an aperture which provides fluid communication with the second chamber portion. The aperture is surrounded by a second seat which faces the second diaphragm. The second diaphragm is deflectable into sealing engagement with the second seat to seal the aperture. A third chamber has a flexible third diaphragm mounted therein. The third diaphragm sealingly divides the third chamber into fifth and sixth chamber portions. The sixth chamber portion is vented to the ambient. The fifth chamber portion is in fluid communication with the second enclosed space. An elongated plunger has one end positioned within the fifth chamber portion. The one end of the plunger is engageable with the third diaphragm. The other end of the plunger is positioned within the fourth chamber portion and is engageable with the second diaphragm. The third diaphragm is deflectable into engagement with the one end of the plunger when the second enclosed space, and thereby the fifth chamber portion, is at a pressure lower than the sixth chamber portion. The plunger is thereupon forced into engagement with the second diaphragm and thereby forces the second diaphragm into sealing engagement with the second seat.

The second diaphragm is deflected out of engagement with the second seat when pressure in the second enclosed space, and thereby the fifth chamber portion, increases to a predetermined value. Fluid in the second chamber portion is permitted to enter the third chamber portion and exit to the ambient, thereby allowing the first diaphragm to deflect out of engagement with the first seat and allowing the fluid to flow from the first enclosed space through the first chamber portion and exit to the ambient, thereby depressurizing the first enclosed space.

The device also includes a set point trigger which comprises a body and a conduit which extends through the body. One end of the conduit is in fluid communication with the fifth chamber portion and the other end of the conduit is in fluid communication with the second enclosed space. An opening in the body provides fluid communication between the conduit and the ambient. A valve seat surrounds the opening. A valve closing member is movably mounted within the body. The closing member is movable into sealing engagement with the seat to close the opening. Biasing means, such as a spring is provided for biasing the valve closing member out of engagement with the seat when fluid pressure within the second enclosed space, and thereby the conduit, rises to a predetermined value thereby opening the conduit and venting the fifth chamber portion to the ambient.

### BRIEF DESCRIPTION OF THE DRAWINGS

FIG. 1 is a schematic view of a negative pressure dry-pipe sprinkler system having a negative pressure actuator according to the invention;

FIG. 2 is a sectional view of a valve actuated by the negative pressure actuator according to the invention; and

FIG. 3 is a sectional view of a negative pressure actuator according to the invention.

### DETAILED DESCRIPTION OF THE EMBODIMENTS

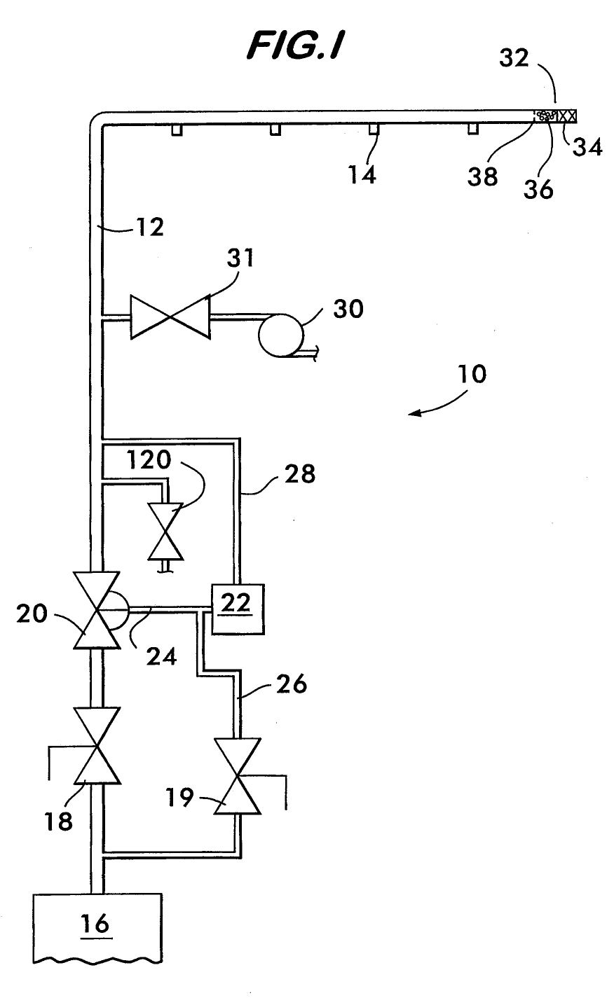

FIG. 1 shows a schematic representation of a negative pressure dry-pipe sprinkler system 10 according to the invention. System 10 comprises a piping network 12 which extends throughout the structure (not shown), such as a building or warehouse, in which the system is installed. Sprinkler heads 14 are mounted on the piping network throughout the structure for the discharge of water or other fire suppressing fluid in the event of a fire. The sprinkler heads have a heat sensitive element which opens the sprinkler in response to heat generated by a fire. Other triggering methods are also feasible.

Piping network 12 is connected to a source of pressurized water 16 or other fire suppressing fluid. In an example system, the source of water 16 may be a municipal water service water main. Water flow from the source 16 to the piping network 12 is controlled by a service valve 18 and a control valve 20. Service valve 18 is used to isolate the entire system 10 from the source 16 so that the components can be serviced, replaced, repaired or reset after actuation due to a fire or a test. When the system is in operation, the service valve 18 is open, allowing pressurized water to the control valve 20. A trim valve 19 is used to provide fluid communication between the source 16 and the mechanisms of control valve 20 and is used to set and reset the control valve during operation as described below.

Control valve 20 controls the flow of water to the piping network 12. In the dry-pipe system 10, the control valve 20 is normally closed and is opened by a negative pressure actuator 22 in response to a fire as described in detail below. Negative pressure actuator 22 is in fluid communication with the control valve 20 through a pipe 24. Both the control valve 20 and the actuator 22 are in fluid communication with pressurized water source 16 through a pipe 26. (Flow of water through pipe 26 is controlled by the aforementioned trim valve 19.) Negative pressure actuator 22 is also in fluid communication with piping network 12 through a pipe 28.

The piping network is maintained at a negative pressure (below atmospheric pressure) by a vacuum pump 30. The vacuum pump is in fluid communication with the piping network through a cut-off valve 31 which is normally open but is closed to protect the pump 30 when water enters the system during test or actuation. The piping network may be substantially fluid tight when all of the sprinkler heads 14 are closed, or it may be a vented system which permits ambient air to be drawn into and flow through the piping network at a controlled rate. For example, the piping network may have one or more vents 32 which comprise a filter 34 for filtering out particulate matter from the ambient air, a desiccant dryer 36 for removing moisture from the ambient air, and an orifice 38 for controlling the rate of flow of ambient air into the system. The piping network in both the fluid tight and vented systems is considered an “enclosed space” as that term is used herein.

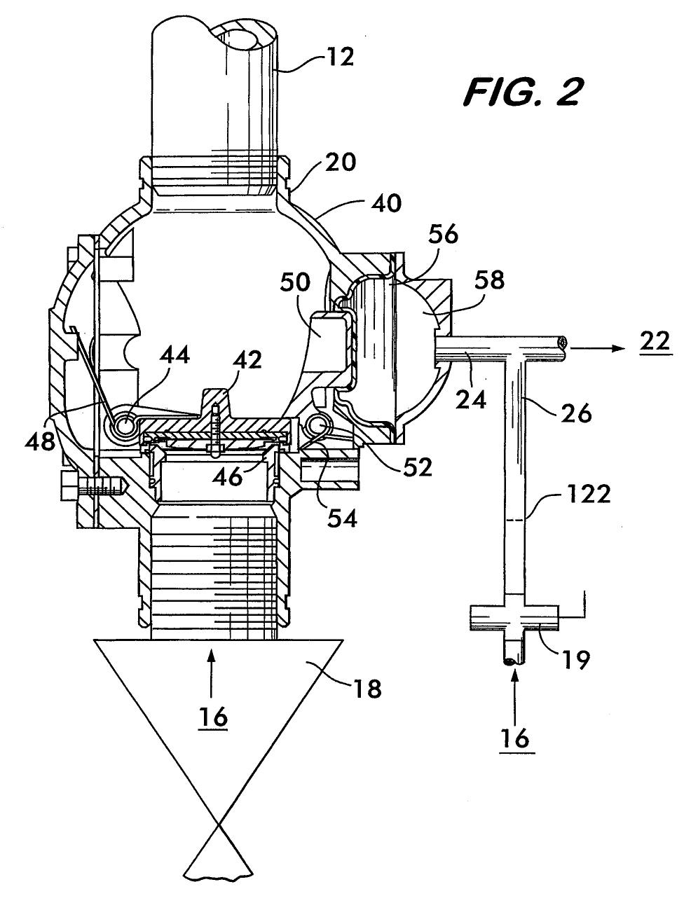

Control valve 20 is shown in detail in FIG. 2 and includes a housing 40 in which a flapper closing member 42 is mounted. Flapper 42 is pivotally mounted for rotation about an axis 44. The flapper is sealingly engageable with a seat 46 to prevent water flow from the source 16 to the piping network 12. The flapper is biased in a closed position by a spring 48 but is more positively held in the closed position against the pressure of source 16 by a latch 50. Latch 50 pivots about another axis 52 and is biased by a spring 54 into a position away from the flapper 42.

When the flapper 22 is closed as shown in FIG. 2, it is held in position against the pressure of source 16 by the latch 50, which in turn, is held in position against the force of flapper 42 and the biasing of spring 54 by a diaphragm 56. Diaphragm 56 is positioned within a chamber 58 (comprising another “closed space” as used herein) mounted on the valve housing 40. Chamber 58 is in fluid communication with the source of pressurized water 16 through pipes 24 and 26 (see also FIG. 1). Water pressure from the source 16 within the chamber 58 acts against the diaphragm 56 to maintain the flapper in the closed position shown. To open the control valve 20, the enclosed space defined by the chamber 58 must be depressurized. A drop in pressure within chamber 58 allows the latch 50 to pivot about axis 52 away from the flapper under the biasing force of spring 54 and the force of the flapper 42. This releases the flapper which pivots about axis 44 into an open position in response to the pressure from source 16 to release water to the piping network 12. The operation of control valve 20 is effected by the negative pressure actuator 22 operating in response to an increase in pressure within the piping network 12 caused by an opening of one or more sprinkler heads 14 allowing ambient air into the network as described in detail below.

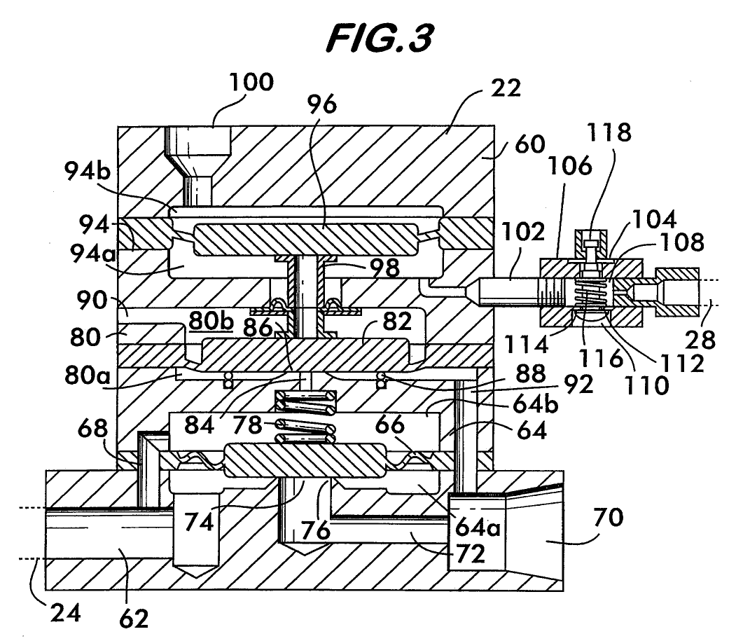

Negative pressure actuator 22 is shown in detail in FIG. 3. Actuator 22 comprises a housing 60 having an inlet 62 that is connected to pipe 24. Inlet 62 is in fluid communication with a first chamber 64 defined within the housing 60. First chamber 64 is divided into respective first and second chamber portions 64a and 64b by a flexible diaphragm 66 sealingly located within the first chamber. The inlet 62 is in fluid communication with both chamber portions 64a and 64b, with a duct 68 extending from the inlet 62 into the second chamber portion 64b. First chamber portion 64a is in fluid communication with the ambient through an outlet 70. A duct 72 connects the first chamber portion 64a to the outlet, the duct having an opening 74 in the first chamber portion defined by a seat 76. Seat 76 is in facing relation with diaphragm 66, which is deflectable into and out of sealing engagement with the opening to open and close it during operation of the actuator 22 as described below. A biasing spring 78 is positioned within the second chamber portion 64b to bias the diaphragm 66 into engagement with the seat 76. Biasing spring 78 is used to help control the pressure differential between chamber portions 64a and 64b at which the diaphragm will move out of engagement with the seat to allow water to flow from the inlet 62 through the opening 74 and through the duct 72 to the outlet 70 during actuator operation.

A second chamber 80 is positioned adjacent to the first chamber 64. Second chamber 80 is sealingly divided into third and fourth chamber portions 80a and 80b by a second diaphragm 82. An aperture 84, located between the first and second chambers 64 and 80 provides fluid communication between the second chamber portion 64b and the third chamber portion 80a. A second seat 86 surrounds the aperture 84. Second seat 86 is in facing relation with the second diaphragm 82, which is flexible and may therefore be deflected into and out of engagement with the seat to open and closed aperture 84. A second biasing spring 88 is located in the third chamber portion 80a to bias the diaphragm out of engagement with seat 86. Spring 88 is used to help control the pressure in chamber portions 80a at which the diaphragm 82 will engage the seat 86 and sealingly close aperture 84. The fourth chamber portion 80b is vented to the ambient through a duct 90 to permit movement of the diaphragm 82 unencumbered by pressure within the fourth chamber portion 80b. A duct 92 extends between the third chamber portion 80a and the outlet 70 to allow water which enters the third chamber portion 80a through aperture 84 to escape to the ambient during actuator operation.

A third chamber 94 is positioned adjacent to the second chamber 80. Third chamber 94 is divided into fifth and sixth chamber portions 94a and 94b by a third flexible diaphragm 96. A plunger 98 is positioned between the fifth chamber portion 94a and the fourth chamber portion 80b beneath it. The plunger 98 is slidably mounted between the chambers 94 and 80, and opposite ends of the plunger are engaged with the third and second diaphragms 96 and 82 such that when the third diaphragm deflects downwardly (caused by a lower pressure in the fifth chamber portion 94a relative to sixth chamber portion 94b), it acts against the plunger which, in turn, acts against the second diaphragm 82 to force it into sealing engagement with the seat 86, closing aperture 84. The sixth chamber portion 94b is vented to the ambient by duct 100 to permit motion unencumbered by pressure within the sixth chamber portion.

The fifth chamber portion 94a is in fluid communication with the piping network 12 through a duct 102 that is connected to pipe 28 (see also FIG. 1). In some embodiments, it is advantageous to position a set point trigger 104 between the pipe 28 and the duct 102 as shown. Set point trigger 104 comprises a body 106 through which a conduit 108 extends providing fluid communication between the duct 102 and the pipe 28. An opening 110 in the body 106 provides fluid communication between the conduit 108 and the ambient. A valve seat 112 surrounds the opening 110 and a valve closing member 114 is mounted in the body and engages the seat. The valve closing member is biased out of engagement with seat 112 by a biasing spring 116. The spring constant of the biasing spring 116 may be chosen so that the valve closing member 114 remains closed as long as a negative pressure below a specific, predetermined value is maintained within the conduit 108 (and hence the piping network 12 and the fifth chamber portion 94a in which the conduit is in fluid communication). When the pressure within the conduit exceeds the specific, predetermined value (the “set point pressure”), the force of the biasing spring overcomes the ambient pressure which holds the valve closing member 114 closed and the closing member disengages from the seat 112 and conduit 108 is opened to the ambient, thereby allowing ambient air to rapidly enter the fifth chamber portion 94a and trigger the actuator 22. A set point pressure of about 5 inches Hg is advantageous. The set point trigger acts as an accelerator, triggering the actuator more quickly than if air entered the fifth chamber from the piping network 12. The set point trigger 104 also includes a manual reset knob 118 which is attached to the valve closing member 114. To set or reset the set point trigger, the manual reset knob is grasped and pulled to engage the valve closing member 114 with the seat 112. The knob is held in this position until the pressure within the conduit is below the set point pressure, at which point the ambient air pressure acting against the valve closing member from outside the body 106 can hold the valve closing member engaged with the seat against the biasing force of spring 116.

### Negative Pressure Actuator Operation

The system 10 shown in FIG. 1 must first be placed in the “ready” mode so that it is ready to detect and suppress a fire. To that end, service valve 18 and trim valve 19 are closed and any water in the piping network is drained through a drain valve 120, usually positioned at the lowest point in the system. The drain valve is then closed.

After the piping network 12 is drained, the vacuum pump cut-off valve 31 is opened and vacuum pump 30 is activated to draw a negative pressure within the network. As noted above, the piping network 12 could be substantially fluid tight or may be vented and draw in ambient air though a filter 34, dryer 36 and orifice 38 at one or more branches. It is understood that even in vented systems negative pressure will be maintained by operation of the vacuum pump, drawing air at a greater flow rate than it is permitted to enter the system as controlled by the orifice or other throttling devices which may be used.

Because, as shown in FIG. 1, the negative pressure actuator 22 is in fluid communication with the piping network 12 through pipe 28, operation of the vacuum pump 30 will also draw a negative pressure in the actuator. As shown in detail in FIG. 3, pipe 28 is connected to the conduit 108 of set point trigger 104. Ambient air will be drawn through opening 110 until the valve closing member 114 is pulled into engagement with valve seat 112 using reset knob 118. This will result in negative pressure being created within body 106 and eventually the negative pressure will drop below the set point pressure, at which the ambient pressure of the atmosphere will hold the valve closing member closed against the biasing force of spring 116.

The set point trigger 104 is in fluid communication with the fifth chamber portion 94a through duct 102, therefore, negative pressure will also be created in the fifth chamber portion. A negative pressure within chamber 94a of about 10 inches Hg is practical. Because the sixth chamber portion 94b is vented to the ambient through duct 100, the third diaphragm 96 will be deflected into the fifth chamber portion by the differential pressure between the fifth and sixth chamber portions. As it deflects, the third diaphragm engages plunger 98 which, in turn, engages the second diaphragm 82. Deflection of the third diaphragm is transmitted to the second diaphragm, forcing it into sealing engagement with seat 86 and closing aperture 84 against the biasing force of spring 88.

In the absence of water pressure within the system, flapper 42 in control valve 20 (see FIG. 2) is closed by its biasing spring 48. Next the trim valve 19 is opened, allowing water from source 16 to flow into chamber 58 and pivot latch 50 against the biasing force of its spring 54 into engagement with flapper 42 to hold the flapper in the closed position against its seat 46, thereby isolating the piping network from the source of pressurized water 16 as is appropriate for a dry-pipe system. Opening of the trim valve 19 also sends water to the negative pressure actuator as described below. With the flapper 42 closed and locked by the latch 50, the service valve 18 is opened to supply water to the control valve 20.

As shown in FIG. 3, with diaphragm 82 engaging seat 86, water from source 16, which is supplied to inlet 62 of the actuator 22 when trim valve 19 is opened (see also FIG. 1), is prevented from passing through duct 68, aperture 84 and duct 92 to the outlet 70. The area ratio between the diaphragm 82 and the aperture 84 ranges between about 600:1 to about 1200:1 to ensure that false tripping of the actuator due to water pressure surges is avoided. The sealing of aperture 84 results in an increase in water pressure within the first chamber 64. Although the water pressure is the same on both sides of the first diaphragm 66, the force exerted by the water pressure on the diaphragm is greater on the side of the first diaphragm which faces the second chamber portion 64b. This is due to the fact that opening 74 is vented to the ambient. The water pressure within second chamber portion 64b, along with the biasing spring 78, force the first diaphragm 66 into engagement with seat 76, closing the opening 74 and preventing water from flowing through the inlet 62, through the opening 74, through the duct 72 and to the ambient through the outlet 70. The system is now set and ready to detect and respond to a fire.

During a fire, one or more of the sprinkler heads 14 open in response to the heat. This allows ambient air to flow into the piping network 12, increasing the pressure otherwise held below atmospheric by the operation of vacuum pump 30. The increase in pressure within the network 12 is conveyed to the set point trigger 104 though pipe 28. When the set point pressure, determined substantially by the biasing spring 116 and the area of the valve closing member 114, is reached, the valve closing member opens, venting the fifth chamber portion 94a to the ambient. This results in a pressure increase in the fifth chamber portion that causes the third diaphragm 96 to disengage from the plunger 98. The absence of force on the plunger 98 permits the spring 88 within the third chamber portion 80a to deflect the second diaphragm 82 out of engagement with seat 86, opening aperture 84 and allowing water to flow from the second chamber portion 64b, into the third chamber portion 80a and through duct 92 to the ambient through outlet 70. The duct 68, which allows water from the inlet 62 into the second chamber portion 64b is sized so that water flows more slowly into the chamber portion than out. This causes a reduction in pressure within the second chamber portion 64b, allowing the force exerted by the water pressure in the first chamber portion 64a to deflect the first diaphragm 66 out of engagement with the seat 76. Water is thus permitted to exit the first chamber portion 64a through the opening 74, the duct 72 and to the ambient through outlet 70. The inlet 62, the opening 74, the duct 72 and the outlet are sized to allow water to flow out of the actuator 22 faster than it is supplied by the pipe 26. Fluid flow to pipe 24 can be inhibited by using an orifice 122 or other flow restricting device in pipe 26 (see FIG. 2), thereby ensuring that pressure is not maintained within the first chamber portion 64a when the first diaphragm 66 disengages from seat 76. As the pressure drops within the first chamber portion 64a it also drops within chamber 58 of the control valve 20, the chamber 58 being in fluid communication with the first chamber portion 64a through pipe 24.

Depressurization of chamber 58 reduces the force on diaphragm 56 and allows the latch 50 to pivot away from flapper 42. Movement of the latch releases any constraint on the flapper, which opens under the water pressure from source 16. Water is thereby provided to the piping network 12 where it is discharged from the open sprinkler heads 14 to suppress the fire. The vacuum pump cut-off valve 31 is closed to prevent water in the network 12 from entering the vacuum pump.

Negative pressure actuators according to the invention allow negative pressure sprinkler systems to be employed enabling their advantages in inhibiting corrosion and scaling to be realized.

What is claimed is:

1. A device for depressurizing a fluid contained in a first enclosed space in response to an increase in fluid pressure in a second enclosed space, said device comprising:
a first chamber having a flexible first diaphragm mounted therein and sealingly dividing said first chamber into first and second chamber portions, both said chamber portions being in fluid communication with said first enclosed space, said first chamber portion having an opening providing fluid communication with the ambient and surrounded by a first seat facing said first diaphragm, said first diaphragm being deflectable into sealing engagement with said first seat to seal said opening when said first enclosed space is pressurized with said fluid;
a second chamber having a flexible second diaphragm mounted therein and sealingly dividing said second chamber into third and fourth chamber portions, said fourth chamber portion being in fluid communication with the ambient, said third chamber portion being in fluid communication with the ambient and having an aperture providing fluid communication with said second chamber portion, said aperture being surrounded by a second seat facing said second diaphragm, said second diaphragm being deflectable into sealing engagement with said second seat to seal said aperture; and
a third chamber having a flexible third diaphragm mounted therein and sealingly dividing said third chamber into fifth and sixth chamber portions, said sixth chamber portion being vented to the ambient, said fifth chamber portion being in fluid communication with said second enclosed space, an elongated plunger having one end positioned within said fifth chamber portion and engageable with said third diaphragm, the other end of said plunger being positioned within said fourth chamber portion and engageable with said second diaphragm, said third diaphragm being deflectable into engagement with said one end of said plunger when said second enclosed space, and thereby said fifth chamber portion, is at a pressure lower than said sixth chamber portion, said plunger being thereupon forced into engagement with said second diaphragm and thereby forcing said second diaphragm into sealing engagement with said second seat, said second diaphragm being deflected out of engagement with said second seat when pressure in said second enclosed space, and thereby said fifth chamber portion, increases to a predetermined value, fluid in said second chamber portion being permitted to enter said third chamber portion and exit to the ambient, thereby allowing said first diaphragm to deflect out of engagement with said first seat and allowing said fluid to flow from said first enclosed space through said first chamber portion and exit to the ambient thereby depressurizing said first enclosed space.

2. A device according to claim 1, further comprising a set point trigger comprising:
a body;
a conduit extending through said body having one end in fluid communication with said fifth chamber portion and the other end in fluid communication with said second enclosed space;
an opening in said body providing fluid communication between said conduit and the ambient;
a valve seat surrounding said opening;
a valve closing member movably mounted within said body and movable into sealing engagement with said seat to close said opening; and
means for biasing said valve closing member out of engagement with said seat when fluid pressure within said second enclosed space, and thereby said conduit, rises to a predetermined value thereby opening said conduit and venting said fifth chamber portion to the ambient.

3. A device according to claim 2, wherein said set point trigger further comprises a manual reset knob attached to said valve closing member and extending from said body, said manual reset knob being manually movable to move said valve closing member against said biasing means into engagement with said valve seat thereby closing said conduit, said valve closing member remaining engaged with said seat as long as fluid pressure within said conduit is below said predetermined value.

4. A device according to claim 3, wherein said biasing means comprises a spring positioned within said conduit, said spring engaging said valve closing member and having a predetermined spring constant for biasing said valve closing member out of engagement with said valve seat when fluid pressure within said conduit rises to a predetermined value.

5. A device according to claim 1, further comprising a biasing means positioned within said first chamber, said biasing means engaging and biasing said first diaphragm into engagement with said first seat.

6. A device according to claim 1, further comprising a biasing means positioned within said second chamber, said biasing means engaging and biasing said second diaphragm away from said second seat.

7. An actuator for depressurizing a valve chamber within a valve and thereby opening said valve in response to an increase in fluid pressure in a piping network of a fire protection sprinkler system, said actuator comprising:
a first chamber having a flexible first diaphragm mounted therein and sealingly dividing said first chamber into first and second chamber portions, both said chamber portions being in fluid communication with said valve chamber, said first chamber portion having an opening providing fluid communication with the ambient and surrounded by a first seat facing said first diaphragm, said first diaphragm being deflectable into sealing engagement with said first seat to seal said opening when said valve chamber is pressurized with said fluid;
a second chamber having a flexible second diaphragm mounted therein and sealingly dividing said second chamber into third and fourth chamber portions, said fourth chamber portion being in fluid communication with the ambient, said third chamber portion being in fluid communication with the ambient and having an aperture providing fluid communication with said second chamber portion, said aperture being surrounded by a second seat facing said second diaphragm, said second diaphragm being deflectable into sealing engagement with said second seat to seal said aperture; and
a third chamber having a flexible third diaphragm mounted therein and sealingly dividing said third chamber into fifth and sixth chamber portions, said sixth chamber portion being vented to the ambient, said fifth chamber portion being in fluid communication with said piping network of said fire protection sprinkler system, an elongated plunger having one end positioned within said fifth chamber portion and engageable with said third diaphragm, the other end of said plunger being positioned within said fourth chamber portion and engageable with said second diaphragm, said third diaphragm being deflectable into engagement with said one end of said plunger when said piping network of said fire protection sprinkler system, and thereby said fifth chamber portion, is at a pressure lower than said sixth chamber portion, said plunger being thereupon forced into engagement with said second diaphragm and thereby forcing said second diaphragm into sealing engagement with said second seat, said second diaphragm being deflected out of engagement with said second seat when pressure in said piping network of said fire protection sprinkler system, and thereby said fifth chamber portion, increases to a predetermined value, fluid in said second chamber portion being permitted to enter said third chamber portion and exit to the ambient, thereby allowing said first diaphragm to deflect out of engagement with said first seat and allowing said fluid to flow from said valve chamber through said first chamber portion and exit to the ambient thereby depressurizing said valve chamber.

8. An actuator according to claim 7, further comprising a set point trigger comprising:
a body;
a conduit extending through said body having one end in fluid communication with said fifth chamber portion and the other end in fluid communication with said piping network;
an opening in said body providing fluid communication between said conduit and the ambient;
a valve seat surrounding said opening;
a valve closing member movably mounted within said body and movable into sealing engagement with said seat to close said opening; and
means for biasing said valve closing member out of engagement with said seat when fluid pressure within said piping network, and thereby said conduit, rises to a predetermined value thereby opening said conduit and venting said fifth chamber portion to the ambient.

9. An actuator according to claim 8, wherein said set point trigger further comprises a manual reset knob attached to said valve closing member and extending from said body, said manual reset knob being manually movable to move said valve closing member against said biasing means into engagement with said valve seat thereby closing said conduit, said valve closing member remaining engaged with said seat as long as fluid pressure within said conduit is below said predetermined value.

10. An actuator according to claim 9, wherein said biasing means comprises a spring positioned within said conduit, said spring engaging said valve closing member and having a predetermined spring constant for biasing said valve closing member out of engagement with said valve seat when fluid pressure within said conduit rises to a predetermined value.

11. An actuator according to claim 7, further comprising a biasing means positioned within said first chamber, said biasing means engaging and biasing said first diaphragm into engagement with said first seat.

12. An actuator according to claim 7, further comprising a biasing means positioned within said second chamber, said biasing means engaging and biasing said second diaphragm away from said second seat.
